(19) United States
(12) Patent Application Publication
(10) Pub. No.: US 2005/0052980 A1
(43) Pub. Date: Mar. 10, 2005

(54) Optical power adjusting method and apparatus

(75) Inventors: Atsuko Shimizu, Kanagawa-ken (JP); Katsuto Sumi, Kanagawa-ken (JP); Daisuke Nakaya, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/935,088

(22) Filed: Sep. 8, 2004

(30) Foreign Application Priority Data
Sep. 8, 2003 (JP) 315711/2003
Sep. 12, 2003 (JP) 321220/2003

(51) Int. Cl. G11B 7/00

(52) U.S. Cl. 369/53.26; 369/116

(57) ABSTRACT

An optical power adjusting method and apparatus for preventing unevenness of exposure of a photosensitive material arising from the difference in wavelength of the light beams. The relationship between the output value and wavelength of the light receiving section is stored in a storage section for a light beam that satisfies the relationship with respect to the optical power and wavelength required for exposing the photosensitive material at a predetermined exposure level. The correspondence between the laser beam emitting section and its wavelength is stored in another storage section. Each laser beam is received separately by the light receiving section, and the optical power of each laser beam is adjusted by the optical power adjusting section such that the output value of the light receiving section for each laser beam received separately satisfies the relationship between the output value and wavelength.

### BACKGROUND OF THE INVENTION

1. Field of the Invention

The present invention relates generally to an optical power adjusting method and apparatus, and more specifically to an optical power adjusting method and apparatus for adjusting the optical power of each of the light beams emitted from a plurality of light emitting sections.

2. Description of the Related Art

Image recording systems for recording image information on a photosensitive material using laser beams emitted from a plurality of laser light sources are known. In the known system, the optical power of each of the laser beams emitted from a plurality of laser light sources is measured by a silicon-based light receiving element in order to adjust the optical power of each of the laser beams to a predetermined level. The sensitivity of the silicon-based light receiving element generally varies with the wavelength of the laser beam received. That is, when two laser beams having different wavelengths are received by the light receiving element, the output values of the light receiving element may differ with each other even if the beams have the same optical power. Therefore, the output value of the light receiving element is adjusted according to the wavelength of each of the laser beams received by the light receiving element to indicate the optical power of each of the laser beams more accurately as described, for example, in Japanese Patent Publication No. 7(1995)-117447.

The sensitivity of the photosensitive material on which an image is recorded when exposed to the laser beam also varies with the wavelength of the laser beams irradiated thereon. That is, when the photosensitive material described above receives laser beams having different wavelengths, the exposure levels of the photosensitive material may differ with each other even if the two beams have the same optical power. Therefore, even if the photosensitive material is exposed to the laser beams after their optical powers are adjusted to the same level by adjusting the output value of the light receiving element according to the wavelength of the laser beams as described above, the image recorded on the photosensitive material may result in a problematic image having unevenness in density caused by these laser beams having different wavelengths.

### SUMMARY OF THE INVENTION

The present invention has been made in recognition of the circumstance described above, and it is an object of the present invention to provide an optical power adjusting means and apparatus capable of preventing unevenness of exposure of a photosensitive material arising from the difference in wavelength of a plurality of the light beams for exposing the photosensitive material.

The optical power adjusting method of the present invention is an optical power adjusting method for adjusting the optical power of a light beam or beams to be emitted from a light emitting section or sections for exposing a photosensitive material comprising the steps of:
(a) determining an intended exposure level of a photosensitive material to be exposed with the use of the light beam or beams, and
(b) adjusting the optical power based on the difference between the exposure level of the photosensitive material obtained by the light beam or beams, which is dependent on the optical power and wavelength thereof, and the intended exposure level.

The optical power adjusting method of the present invention may be adapted to implement the optical power adjustment based on the difference between the output value obtained by receiving the light beam having a known wavelength by a light receiving element and the corresponding value to the intended exposure level at the wavelength.

Further, it may be adapted to implement the optical power adjustment based on the difference between the output value obtained by receiving the light beam by a light receiving element through an optical filter and the value corresponding to the intended exposure level, wherein the transmission characteristic of the optical filter is adjusted such that the output value indicates the characteristic that corresponds to the exposure level of the photosensitive material based on the wavelength characteristic of the light receiving element and the photosensitive material.

Still further, it may be adapted to implement the optical power adjustment for each of the light beams emitted from a plurality of the light emitting sections and the step (b) described above comprises the_steps of:
obtaining the relationship between the output value outputted from the light receiving section when a light beam that satisfies the relationship with respect to the optical power and wavelength required for exposing the photosensitive material at the intended exposure level is received thereby and the wavelength of the light beam in advance,
receiving each of the light beams emitted from the plurality of light emitting sections separately by the light receiving section, and adjusting the optical power of each of the light beams emitted from the plurality of light emitting sections such that each of the output values outputted from the light receiving section for each of the light beams received separately by the light receiving section satisfies the relationship between the output value and wavelength.

Further it may be adapted to implement the optical power adjustment for each of the light beams emitted from a plurality of the light emitting sections and the step (b) described above comprises the steps of:
providing an optical filter having an optical transmission characteristic that causes the light receiving section to output a predetermined constant output value when a light beam that satisfies the relationship between the optical power and wavelength required for exposing the photosensitive material at the intended exposure level is received thereby through the optical filter,
receiving each of the light beams emitted from the plurality of light emitting sections separately by the light receiving section through the optical filter, and
adjusting the optical power of each of the light beams emitted from the plurality of light emitting sections such that each of the output values outputted from the light receiving section for each of the light beams received separately by the light receiving section corresponds to the predetermined constant output value.

The optical power adjusting apparatus of the present invention is an optical power adjusting apparatus comprising:
a light receiving section for receiving a light beam or beams emitted from a light emitting section or sections for exposing a photosensitive material to obtain the optical power of the light beam or beams, and
correcting section for correcting the optical power based on the difference between the exposure level of the photosensitive material obtained by the light beam or beams, which is dependent on the optical power and wavelength thereof, and an intended exposure level of the photosensitive material.

The light receiving section described above may be configured to receive each of the light beams emitted from a plurality of the light emitting sections separately and to output the output value that indicates the optical power of each of the light beams, and the correcting section may comprise an optical power adjusting section for adjusting the optical power of each of the light beams emitted from the plurality of light emitting sections and a storage section for storing the output value/wavelength relationship, which is the relationship between the output value outputted from the light receiving section when a light beam that satisfies the relationship with respect to the optical power and wavelength required for exposing the photosensitive material at a predetermined constant exposure level is received thereby, and the wavelength, wherein each of the light beams emitted from the plurality of light emitting sections is received separately by the light receiving section, and the optical power of each of the light beams to be emitted from the plurality of light emitting sections is adjusted by the optical power adjusting section such that each of the output values outputted from the light receiving section for each of the light beams received separately by the light receiving section satisfies the output value/wavelength relationship stored in the storage section.

Further, the light receiving section may be configured to receive each of the light beams emitted from a plurality of the light emitting sections separately, and the correcting section may comprise an optical filter disposed between the light emitting section and light receiving section, having an optical transmission characteristic that causes the light receiving section to output a predetermined constant output value when a light beam that satisfies the relationship with respect to the optical power and wavelength required for exposing the photosensitive material at a predetermined constant exposure level is received thereby through the optical filter, and an optical power adjusting section for adjusting the optical power of each of the light beams emitted from the plurality of light emitting sections such that each of the output values outputted from the light receiving section for each of the light beams received separately by the light receiving section through the optical filter corresponds to the predetermined constant output value.

The term “exposing the photosensitive material at a predetermined constant exposure level” as used herein means that the photosensitive material is exposed at a predetermined constant exposure level. For example, when different areas within the photosensitive material are exposed at the same exposure level, these areas show the same density when developed.

The optical power adjusting method and apparatus of the present invention is an optical power adjusting method and apparatus for adjusting the optical power of the light beam or beams to be emitted from the light emitting section or sections for exposing a photosensitive material, in which an intended exposure level of a photosensitive material to be exposed with the use of the light beam or beams emitted from the light emitting section or sections is determined, then the optical power of the light beam or beams emitted from the light emitting section or sections is adjusted based on the difference between the exposure level of the photosensitive material obtained by the light beam or beams, which is dependent on the optical power and wavelength thereof, and the intended exposure level, so that more accurate adjustment of the optical power of the light beam or beams may be implemented.

When the optical power adjustment method and apparatus described above is adapted to implement the optical power adjustment for each of the light beams emitted from a plurality of the light emitting sections, in which the relationship between the output value outputted from the light receiving section when a light beam that satisfies the relationship with respect to the optical power and wavelength required for exposing the photosensitive material at a predetermined constant exposure level is received thereby and the wavelength of the light beam is obtained in advance, then each of the light beams emitted from the plurality of light emitting sections is received separately by the light receiving section, and the optical power of each of the light beams emitted from the plurality of light emitting sections is adjusted such that each of the output values outputted from the light receiving section for each of the light beams received separately by the light receiving section satisfies the relationship between the output value and wavelength described above, the optical power of each of the light beams emitted from the plurality of light emitting sections may be adjusted such that the photosensitive material is exposed at a predetermined constant exposure level even if each of the light beams emitted from the plurality of light emitting sections has a different wavelength with each other. Thus, the unevenness of exposure of the photosensitive material arising from the difference in wavelength of each of the light beams described above may be prevented.

When the optical power adjustment method and apparatus described above is adapted to implement the optical power adjustment for each of the light beams emitted from a plurality of the light emitting sections, in which the optical filter is provided having an optical transmission characteristic that causes the light receiving section to output a predetermined constant output value when a light beam that satisfies the relationship between the optical power and wavelength required for exposing the photosensitive material at a predetermined exposure level is received thereby through the filter, then each of the light beams emitted from the plurality of light emitting sections is received separately by the light receiving section through the filter and the optical power of each of the light beams emitted from the plurality of light emitting sections is adjusted such that the each of the output values outputted from the light receiving section for each of the light beams received separately by the light receiving section corresponds to the predetermined constant output value, the optical power of each of the light beams emitted from the plurality of light emitting sections may be adjusted such that the photosensitive material is exposed at a predetermined constant exposure level even if each of the light beams emitted from the plurality of light emitting sections has a different wavelength with each other. Thus, the unevenness of exposure of the photosensitive material arising from the difference in wavelength of each of the light beams described above may be prevented. Further, the photosensitive material is exposed at a predetermined constant level when each of the light beams emitted from the plurality of light emitting sections is adjusted such that the output value outputted from the light receiving section for each of the light beams received separately by the light receiving section corresponds to the predetermined constant output value, so that the adjustment of the optical power of each of the light beams emitted from the plurality of light emitting sections may be implemented with ease.

### BRIEF DESCRIPTION OF THE DRAWINGS

FIG. 1 is a block diagram illustrating a schematic configuration of the optical power adjusting apparatus of the present invention.

FIG. 2 is a graph illustrating the output/wavelength relationship.

FIG. 3 is a graph illustrating the spectral sensitivity characteristic of the light receiving element.

FIG. 4 is a partially enlarged graph of FIG. 3.

FIG. 5 is a graph illustrating the appropriate optical power of exposure for the photosensitive material.

FIG. 6 is a graph illustrating an example of an overall wavelength distribution range of a combined laser beam divided into a plurality of smaller wavelength ranges.

FIG. 7 is a perspective view of the optical power adjusting apparatus according to a second embodiment of the present invention illustrating the schematic configuration thereof.

FIG. 8 is a graph illustrating the predetermined constant output value outputted from the light receiving section.

FIG. 9 is a graph illustrating the spectral sensitivity characteristic of the light receiving section.

FIG. 10A is a graph illustrating a portion of spectral sensitivity characteristic of the light receiving section in enlarged form.

FIG. 10B is a graph illustrating the appropriate optical power of exposure for the photosensitive material.

FIG. 10C is a graph illustrating the optical power adjustment error arising from the spectral sensitivity characteristic of the light receiving section and appropriate optical power of exposure.

FIG. 11A is a graph illustrating the effective spectral sensitivity of the light receiving section.

FIG. 11B is a graph illustrating the appropriate optical power of exposure for the photosensitive material.

FIG. 11C is a graph illustrating the relationship between the adjusted optical power and appropriate optical power to be emitted when the optical filter is placed on the light receiving section.

FIG. 12A is a graph illustrating the transmission characteristic of the optical filter.

FIG. 12B is a graph illustrating the spectral sensitivity characteristic of the light receiving section.

FIG. 12C is a graph illustrating the effective spectral sensitivity characteristic of the light receiving section having the optical filter placed thereon.

### DESCRIPTION OF THE PREFERRED EMBODIMENTS

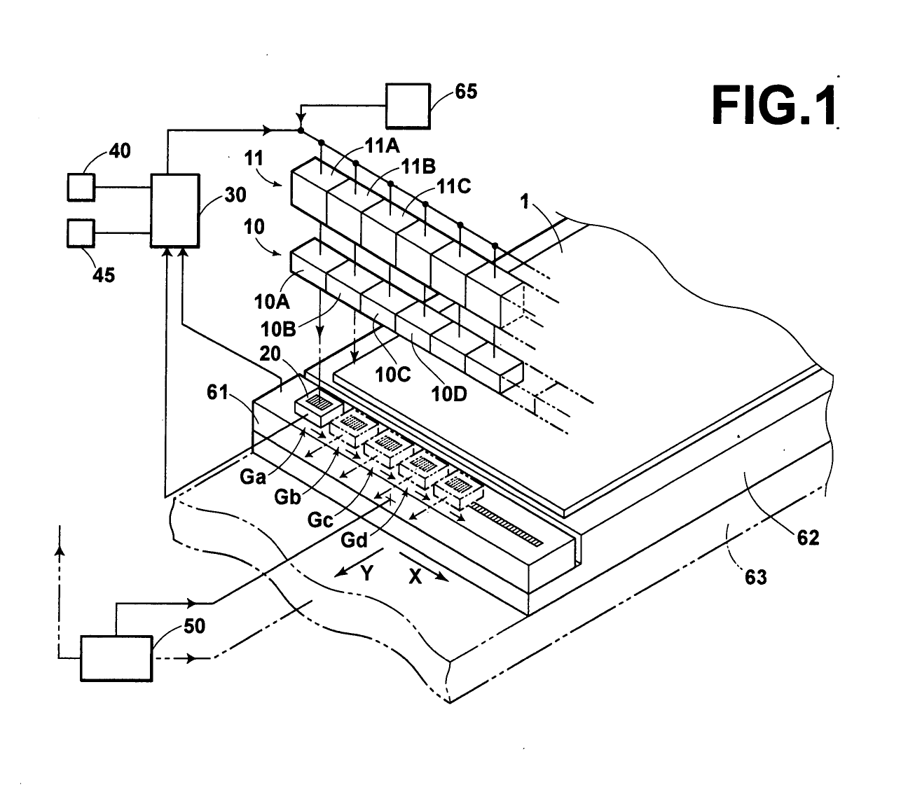

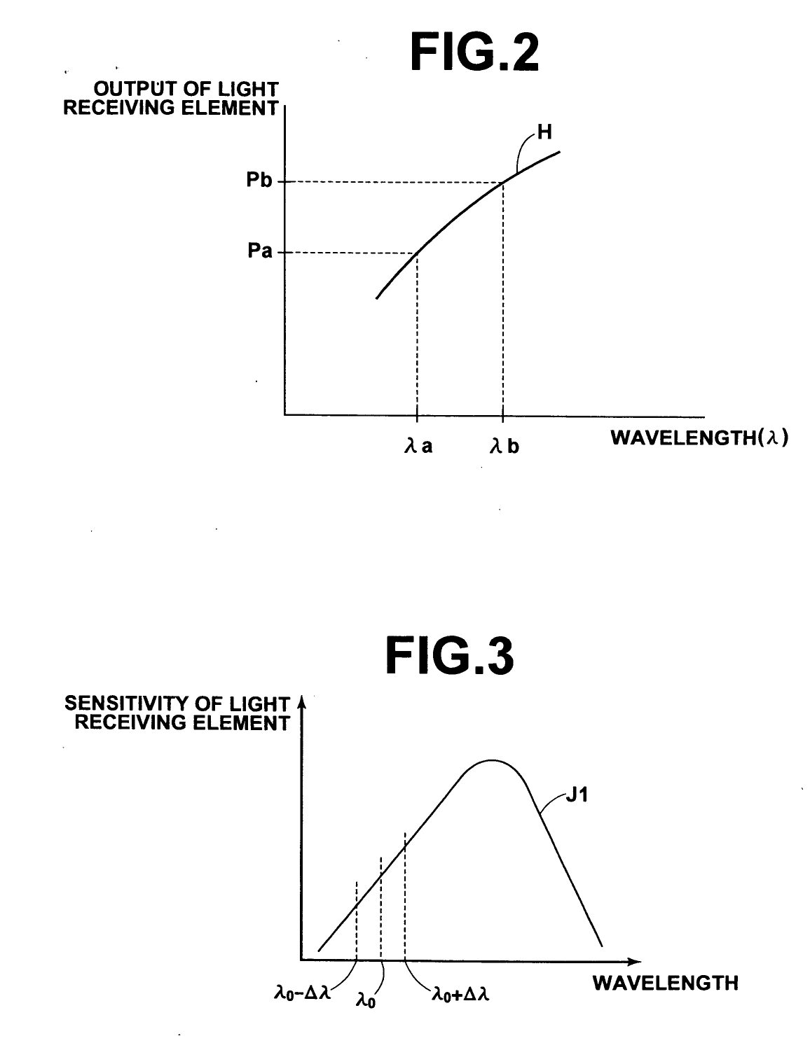

Hereinafter a first embodiment of the present invention will be described with reference to the accompanying drawings. FIG. 1 is a block diagram illustrating a schematic configuration of the optical power adjusting apparatus for implementing a first embodiment of the optical power adjusting method of the present invention. FIG. 2 is a graph illustrating the output/wavelength relationship, which will be described herein below, with the vertical and horizontal axes indicating the output value and wavelength respectively.

The optical power adjusting apparatus according to a first embodiment of the present invention comprises: a light receiving section 20 for separately receiving each of the laser beams emitted from laser beam emitting sections 10A, 10B, - - - (which are also collectively referred to as “laser beam emitting sections 10”) for exposing a photosensitive material 1, acting as a plurality of light emitting means for exposing a photosensitive material and outputting the output value that indicates the optical power of each of the laser beams; an optical power adjusting section 30 for adjusting the optical power of each of the laser beams emitted from the laser beam emitting sections 10A, 10B, - - - ; and an output/wavelength storage section 40 for storing the relationship between the output value outputted from the light receiving section 20 when a laser beam that satisfies the relationship with respect to the optical power and wavelength required for exposing the photosensitive material 1 at a predetermined exposure level is received thereby and its wavelength.

The plurality of laser beam emitting sections 10A, 10B, - - - are disposed linearly in the direction indicated by the arrow X in FIG. 1, and driven by the corresponding laser light source driving sections 11A, 11B, - - - (which are also collectively referred to as “laser light source driving sections 11”).

The light receiving section 20 comprises a silicon-based light receiving element, which is moved by a moving section 61 in the direction indicated by the arrow X, and sequentially placed at the positions for receiving the respective laser beams.

The optical power adjusting section 30 adjusts the optical power of each of the laser beams emitted from the laser beam emitting sections 10A, 10B, - - - , through each of the corresponding laser light source driving sections 11A, 11B - - - , such that the output value outputted from the light receiving section 20 when each of the laser beams emitted from the laser beam emitting sections 10A, 10B, - - - for exposing the photosensitive material 1 is received separately by the light receiving section 20 satisfies the relationship between the output value and wavelength stored in the output/wavelength storage section 40.

The photosensitive material 1 may be a substrate with photoresist being applied thereon for producing a two-dimensional circuit pattern for use with a printed circuit board, crystal display board, or plasma display board.

The moving section 61 for moving the light receiving section 20 is disposed on a mounting board 62 on which the photosensitive material 1 is placed. The mounting board 62 is conveyed in the direction indicated by the arrow Y in FIG. 1, which is orthogonal to the X direction described above, by a conveyor section 63.

The wavelength of each of the laser beams emitted from the laser beam emitting sections 10A, 10B, - - - is measured in advance, and the correspondence between each of the laser beam emitting sections 10A, 10B, - - - and its wavelength is stored in a light source/wavelength storage section 45. As for the wavelength described above, the peak wavelength of each of the laser beams is selected.

Overall operation of the apparatus, including operation of each component described above, input/output signal timings, and the like is controlled by a controller 50.

The output/wavelength relationship that represents the relationship between the output value when a laser beam that satisfies the relationship with respect to the optical power and wavelength for exposing the photosensitive material 1 at a predetermined constant exposure level is received by the light receiving section 20 and its wavelength may be, for example, as illustrated by the line H in FIG. 2, which indicates that the output value increases as the wavelength increases. The output/wavelength storage section 40 keeps the output/wavelength relationship described above as, for example, a lookup table or function.

The output value indicating the optical power of the laser beam outputted from the light receiving section 20 may be the output value for indicating the optical power of the laser beam per unit time received by the light receiving section 20, or if the laser beam outputted from the laser beam emitting sections 10 is a pulse laser, it may be the output for indicating the optical power of a single pulse received by the light receiving section 20 or the like.

The operation of the optical power adjusting apparatus according to the first embodiment will be described hereinafter.

The moving section 61 moves the light receiving section 20 in the X direction described above, and places it at the receiving position Ga for receiving the laser beam emitted from the laser beam emitting section 10A. The light receiving section 20 placed at the receiving position Ga receives the laser beam emitted from the laser beam emitting section 10A, and the output value outputted from the light receiving section 20 for the laser beam received thereby is inputted to the optical power adjusting section 30. In addition, the moving section 61 outputs a signal to the optical power adjusting section 30 to indicate that the light receiving section 20 has been moved to the position for receiving the laser beam emitted from the laser beam emitting section 10A.

The optical power adjusting section 30 obtains the wavelength λa of the laser beam emitted from the laser beam emitting section 10A with reference to the light source/wavelength storage section 45 after receiving the signal outputted from the moving section 61 and confirming that the laser beam received by the light receiving section 20 is the one emitted from the laser beam emitting section 10A. Further, the optical power adjusting section 30 obtains the output value Pa that satisfies the output/wavelength relationship described above for the wavelength λa with reference to the output/wavelength storage section 40(FIG. 2).

Thereafter, the optical power adjusting section 30 controls the laser light source driving section 1A so that the driving current supplied from the laser light source driving section 11A to the laser beam emitting section 10A is adjusted such that the output value outputted from the light receiving section 20 for the laser beam emitted from the laser beam emitting section 10A corresponds to the output value Pa described above.

The laser light source driving section 11A clamps the optical power of the laser beam emitted from the laser beam emitting section 10A after the optical power of the laser beam emitted therefrom is adjusted such that the output value outputted from the light receiving section 20 for the laser beam emitted therefrom corresponds to the output value Pa. This concludes the adjustment of the optical power of the laser beam emitted from the laser beam emitting section 10A.

Then, the moving section 61 moves the light receiving section 20 in the X direction, and places it at the receiving position Gb for receiving the laser beam emitted from the laser beam emitting section 10B. The light receiving section 20 placed at the receiving position Gb receives the laser beam emitted from the laser beam emitting section 10B, and the output value outputted from the light receiving section 20 for the laser beam received thereby is inputted to the optical power adjusting section 30. In addition, the moving section 61 outputs a signal to the optical power adjusting section 30 to indicate that the light receiving section 20 has been moved to the position for receiving the laser beam emitted from the laser beam emitting section 10B.

The optical power adjusting section 30 obtains the wavelength λb of the laser beam emitted from the laser beam emitting section 10B with reference to the light source/wavelength storage section 45 after receiving the signal outputted from the moving section 61 and confirming that the laser beam received by the light receiving section 20 is the one emitted from the laser beam emitting section 10B. Further, the optical power adjusting section 30 obtains the output value Pb that satisfies the output/wavelength relationship described above for the wavelength λb with reference to the output/wavelength storage section 40(FIG. 2).

Then, the optical power of the laser beam emitted from the laser beam emitting section 10B is adjusted by the optical power adjusting section such that the output value outputted from the light receiving section 20 for the laser beam emitted from the laser beam emitting section 10B corresponds to the output value Pb in the same manner as described above.

Thereafter, the light receiving section 20 is placed in sequence at the receiving positions Gc, Gd, - - - for receiving the laser beams emitted from the laser beam emitting sections 10C, 10D, - - - respectively, and the optical powers of the light beams emitted from the laser beam emitting sections 10C, 10D, - - - are adjusted and clamped in the same manner as described above. This concludes the adjustment of the optical power for all the laser beam emitting sections 10A, 10B, - - - .

When the adjustment of the optical power of each of the laser beams emitted from the laser beam emitting sections 10A, 10B, - - - is completed, the conveyor section 63 conveys the mounting board 62 in the direction indicated by the arrow Y which is orthogonal to the direction indicated by the arrow X in which the laser beam emitting sections 10A, 10B, - - - are arranged.

The controller 50 controls the laser beam emitting sections 10 or laser light source driving sections 11 so that the laser beams emitted from the laser beam emitting sections 10A, 10B, - - - are switched on and off in synchronization with the conveyance of the mounting board 62 such that the image indicated by the image data which have been inputted and stored in an image drawing section 65 is recorded on the photosensitive material 1 placed on the mounting board 62. This causes the image described above to be exposed on the photosensitive material 1. Here, the optical power of each of the laser beams emitted from the laser beam emitting sections 10 for exposing the photosensitive material is the clamped value as described above, so that each output value outputted from the light receiving section 20 for each of the laser beams emitted from the laser emitting sections 10 and its wavelength is in the relationship that satisfies the output/wavelength relationship.

By adjusting the optical power of each of the laser beams emitted from the laser beam emitting sections in the manner described above, the photosensitive material 1 may be exposed at the same exposure level even if each of the laser beams emitted from the laser beam emitting sections has a different wavelength, so that unevenness of exposure of the photosensitive material may be prevented.

The optical power of each of the laser beams emitted from the laser beam emitting sections may be adjusted by disposing an aperture structure on the laser beam emitting section for limiting the cross sectional area of the light path of the laser beam and adjusting the aperture, as well as by adjusting the driving current to be supplied to the laser light source driving section.

In the first embodiment of the present invention described above, the correspondence between the laser beam emitting section and its wavelength is stored in the light source/wavelength storage section, but the wavelength information of each of the laser beams may also be inputted manually to the optical power adjusting section each time the optical power of each of the laser beams emitted from the laser beam emitting sections is adjusted.

The light receiving section described above may be configured to detect the wavelength of the laser beam emitted from the laser beam emitting sections, as well as the optical power thereof and automatically input the wavelength information to the optical power adjusting section.

Further, the light emitting means is not limited to those that emit a laser beam having a narrow wavelength range obtained from a single laser light source, but it may be those that emit a combined laser beam having a wider wavelength range obtained by combining laser beams emitted from a plurality of laser light sources. In addition, the light emitting means is not limited to those that emit a laser beam, but it may be those that emit a light beam having a wide wavelength range obtained from a halogen or mercury lamp, or the like.

If each of the laser beam emitting sections is the type that emits a laser beam having a wide wavelength range like the combined laser beam described above, the optical power thereof is adjusted in the manner as will hereinafter be described in detail, in which the overall wavelength range in which the wavelengths of the combined laser beam emitted from the laser beam emitting section are distributed is divided into a plurality of narrowly divided wavelength ranges, then multiplication results are obtained by multiplying the ratio of the optical power of each of the narrowly divided wavelength ranges to the optical power of the overall wavelength range of the combined laser beam to the output value (outputted from the light receiving section, and hereinafter the output value outputted from the light receiving section will also be referred to as “light receiving section output value”) that satisfies the output/wavelength relationship described above for the center wavelength of each of the narrowly divided wavelength ranges, and finally each of the laser light source driving sections is controlled so that the driving current to be supplied to each of the laser beam emitting sections is adjusted such that the total sum of these multiplication results across the overall wavelength range corresponds to the light receiving section output value described above. This optical power adjusting method may be applied, for example, to the photolithography machine as described, for example, in Japanese Unexamined Patent Application No. 2002-202442 proposed by the applicant. That is, the optical power of each combined laser beam emitted from each of the exposure heads acting as the light emitting means of the photolithography machine described above may be adjusted using the optical power adjusting method described above.

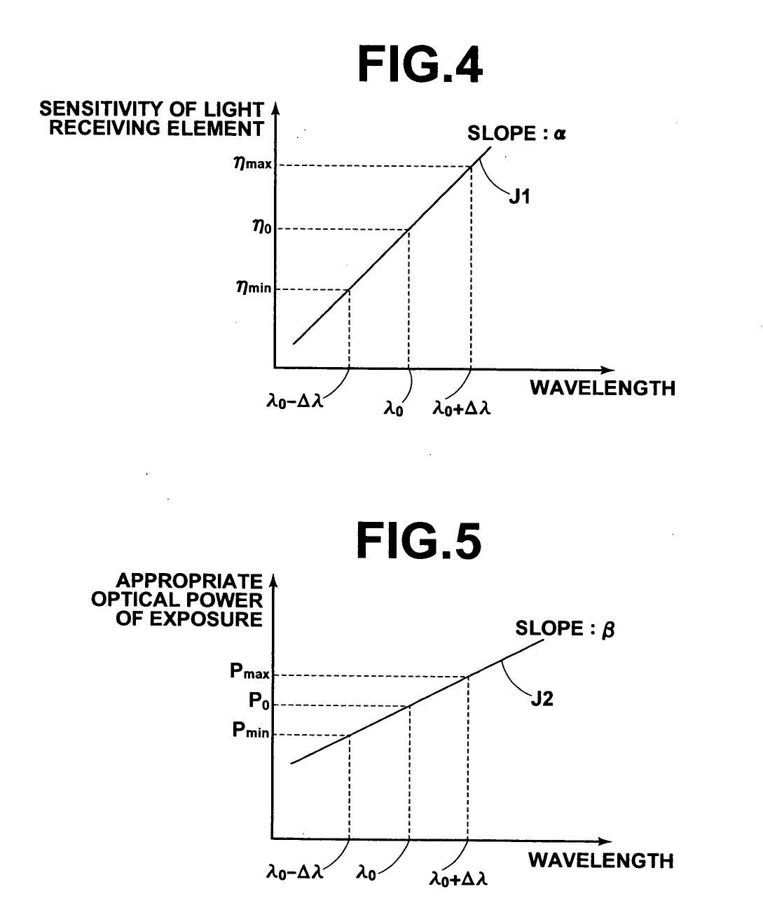

Hereinafter, the adjusting method in which the optical power of each of the light beams emitted from a plurality of light emitting means is adjusted such that it satisfies the output/wavelength relationship will be described in detail. FIG. 3 is a graph illustrating the spectral sensitivity characteristic of the light receiving element with the vertical and horizontal axes indicating the sensitivity and wavelength respectively, and FIG. 4 is the partially enlarged graph of FIG. 3. FIG. 5 is a graph illustrating the appropriate optical power of exposure.

The light beams emitted from a plurality of light emitting elements acting as light emitting means have different peak wavelengths, and it is assumed that they are distributed within the range from λ0−Δλ to λ0+Δλ with λ0 at the center. The correspondence between each of the light emitting elements and its peak wavelength is stored as a parameter.

The general spectral sensitivity characteristic of a silicon-based light receiving element is illustrated by the line J1 in FIG. 3. If semiconductor lasers, each emits a laser beam having a wavelength around 400 nm are used as the plurality of light emitting elements, and the wavelength variance of each of the laser beams is in the range of several tens of nanometers, for example, then the spectral sensitivity characteristic curve of the light receiving element may be approximated as a straight line within the range of the varied wavelengths described above.

FIG. 4 illustrates the aforementioned wavelength range of the line J1 in FIG. 3 in enlarged form. Here, it is assumed that the slope of the approximated straight line of the line J1 within the wavelength range described above is α, which is stored as a parameter. The sensitivity η of the light receiving element for any wavelength λ within the wavelength range described above may be obtained by the following formula, assuming that the sensitivity of the light receiving element is ηo for the reference wavelength λo, which is the center wavelength of the peak wavelength distributions described above.
η=ηo+α(λ−λo) Formula 1

The appropriate optical power of exposure is illustrated, as an example, for the photosensitive material within the wavelength range from λo−Δλ to λo+Δλ with λo at the center by the line J2 in FIG. 5. The appropriate optical power of exposure is the optical power for exposing the photosensitive material at a predetermined appropriate exposure level. The slope of the approximated straight line of the line J2 is assumed to be β, which is stored as a parameter. The appropriate optical power of exposure P for any wavelength λ within the wavelength range described above may be obtained by the following formula, assuming that the appropriate optical power of exposure for the reference wavelength λo which is the center wavelength of the wavelength range described above is Po.
P=Po+β(λ−λo) Formula 2

In order to adjust the optical power of each of the light beams emitted from the light emitting elements for exposing the photosensitive material to the appropriate optical power of exposure, first, the appropriate optical power of exposure for the reference wavelength λo is set externally. This allows the appropriate optical power of exposure for the wavelength of each of the light emitting elements to be calculated by Formula 2, thus, the appropriate optical power of exposure for each of the light emitting elements is obtained using the Formula 2. The optical power of each of the light beams emitted from the light emitting elements is adjusted, for example, by emitting each of the light beams emitted from the light emitting elements onto the light receiving element sequentially, and adjusting the driving current for each of the light emitting elements such that the optoelectrically converted current output (that indicates the optical power per unit time) outputted from the light receiving element for each of the light beams described above corresponds to the predetermined target value, thereby the optical power of each of the light beams (for exposing the photosensitive material) emitted from the light emitting elements is adjusted to the appropriate optical power of exposure. The predetermined target value for the optoelectrically converted current output outputted from the light receiving element may be calculated by the following formula, Formula 3, which may be derived from Formulae 1 and 2.
I=η×P={ηo+α(λ−λo)}{Po+β(λ−λo)} Formula 3

In Formula 3, only the wavelength λ is the specific parameter of each of the light emitting elements, and η, α, β are uniquely determined by defining the reference wavelength λo. The appropriate optical power of exposure Po for the reference wavelength λo may be set according to the photosensitive material to be used.

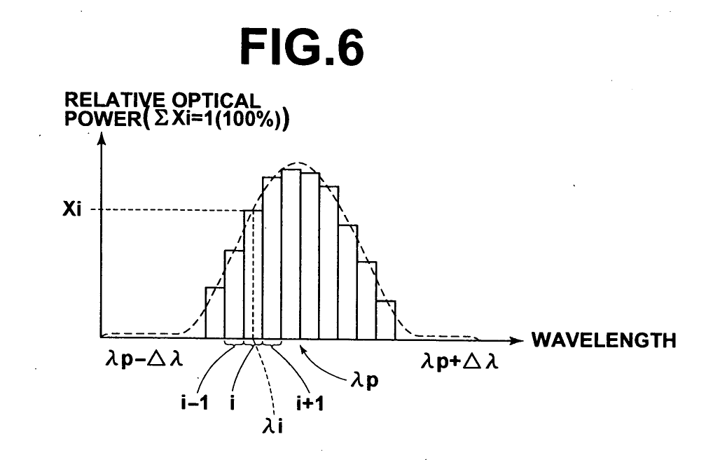

Hereinafter, the optical power adjusting method for the combined laser beam emitted from the laser beam emitting sections, which is composed of laser beams emitted from a plurality of laser light sources and has a wide wavelength range extending from λp−Δλ to λp+Δλ with the wavelength λp at the center as illustrated in FIG. 6 will be described. FIG. 6 is a graph illustrating an example of an overall wavelength distribution range of a combined laser beam divided into a plurality of smaller wavelength ranges with the horizontal and vertical axes indicating the wavelength and relative optical power respectively. The relative optical power described above indicates the ratio of the optical power of the combined laser beam in each of the divided wavelength ranges to that in the overall wavelength range which is assumed to be 1 (100%).

The target value of the optoelectrically converted current output for center wavelength λi in a certain divided range i may be calculated by Formula 3 described above. The target value I of the optoelectrically converted current output for the combined laser beam may be calculated by Formula 4 below, assuming that the relative optical power in the divided range i is Xi, and the target value of the optoelectrically converted current output for the center wavelength λi in the divided range i obtained by Formula 3 is Ii.
I=ΣXi×Ii Formula 4

When each of the light beams emitted from a plurality of light emitting elements has a different peak wavelength and the light receiving section or photosensitive material has a wavelength dependent sensitivity within the wavelength range in which the peak wavelengths are distributed, the wavelength dependent sensitivity may be adjusted through the procedure described above, thereby a constant image without unevenness in image quality may be formed.

The light receiving section is not limited to that composed of a silicon-based light receiving element, and it may be composed of anything as long as it is capable of outputting an output value that indicates the optical power of the light beam received.

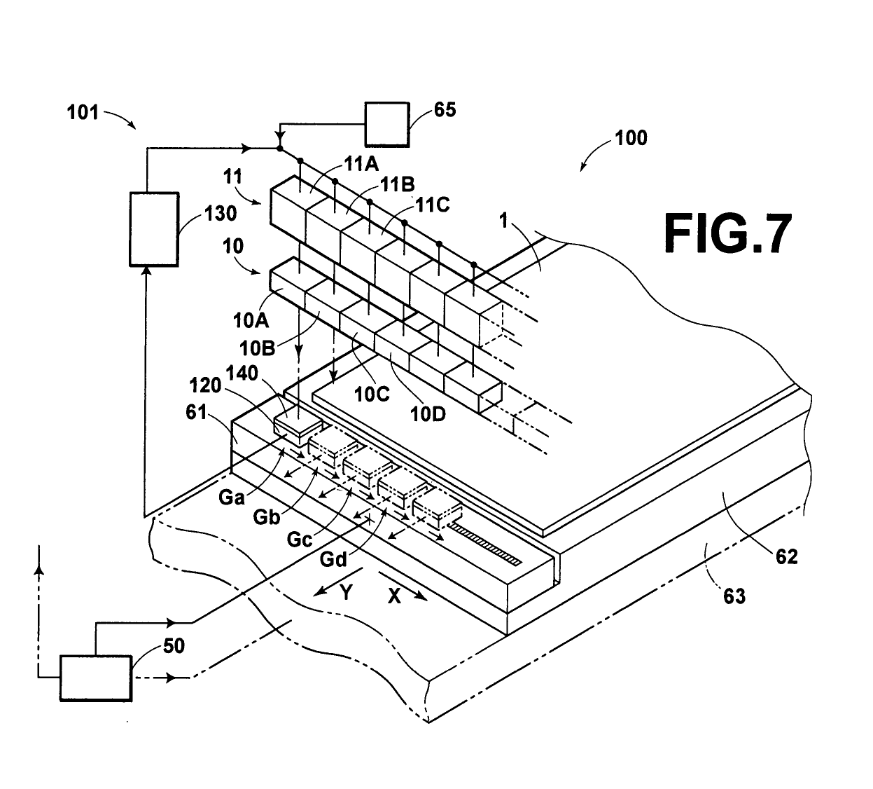

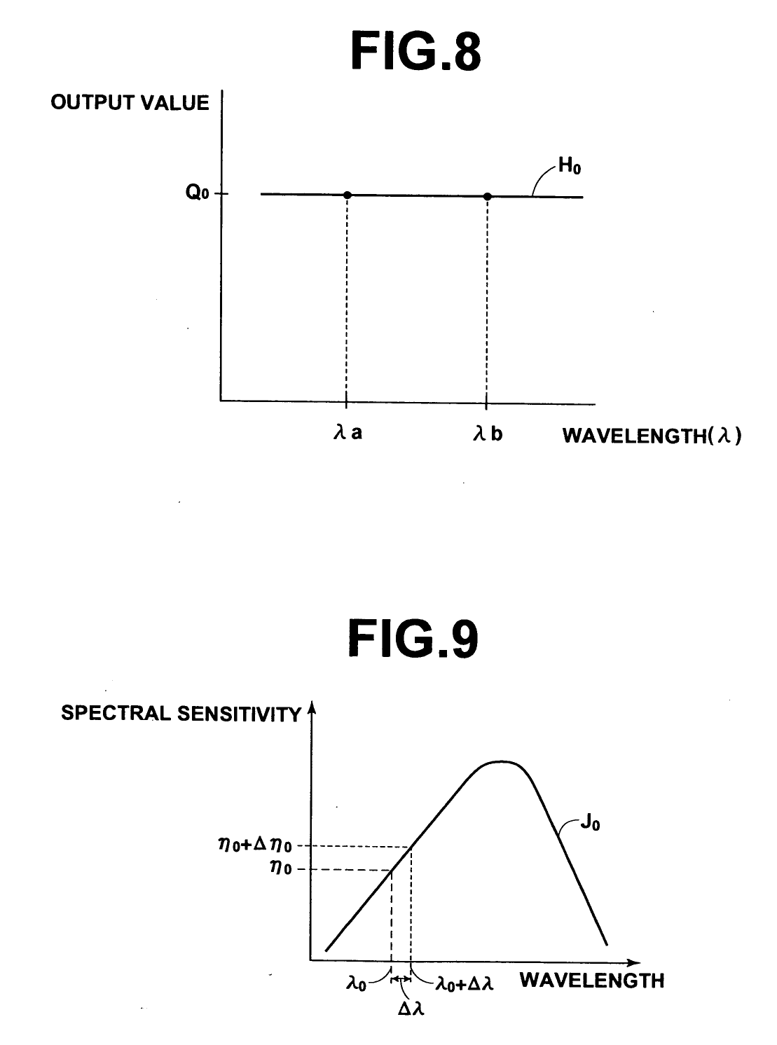

Hereinafter, a second embodiment of the present invention will be described with reference to the accompanying drawings. FIG. 7 is a perspective view of a photolithography machine having an optical power adjusting apparatus mounted thereon for implementing the optical power adjusting method of a second embodiment of the present invention illustrating a schematic configuration thereof. FIG. 8 is a graph illustrating a predetermined constant output value outputted from a light receiving section with the vertical and horizontal axes indicating the output and wavelength respectively. In the second embodiment, components having the identical functions to those used in the first embodiment will be given the same reference numerals.

An optical power adjusting apparatus 101 of the present invention mounted on a photolithography machine 100 comprises: a light receiving section 120 for separately receiving each of the laser beams emitted from laser emitting sections 10A, 10B, - - - (which are also collectively referred to as “laser beam emitting sections 10”) acting as a plurality of light emitting means for exposing a photosensitive material; an optical filter 140 disposed between each of the laser beam emitting sections 10 and the light receiving section 120; and an optical power adjusting section for adjusting the optical power of each of the laser beams emitted from the laser emitting sections 10.

The optical transmission characteristic of the optical filter 140 is set such that the light receiving section 120 outputs a predetermined constant output value when a light beam that satisfies the relationship with respect to the optical power and wavelength for exposing a photosensitive material 1 at a predetermined constant exposure level is received by the light receiving section 120 through the optical filter 140. The output value outputted from the light receiving section 120 when a light beam that satisfies the relationship with respect to the optical power and wavelength for exposing the photosensitive material 1 at the predetermined constant exposure level is received by the light receiving section 120 through the optical filter 140 is constant as illustrated by the straight line Ho in FIG. 8 regardless of the wavelength of the light beam received by the light receiving section 120, and this constant value Qo is referred to as the predetermined constant output value described above.

The optical filter 140 described above may be produced by the common method of layering thin films on a glass substrate.

The optical power adjusting section 130 adjusts the optical power of each of the laser beams emitted from the laser beam emitting sections 10A, 10B, - - - , such that each output value outputted from the light receiving section 120 when each of the laser beams emitted from the laser beam emitting sections 10A, 10B, - - - is received separately by the light receiving section 120 corresponds to the predetermined constant output value Qo described above.

The laser beam emitting sections 1A, 10B, - - - are arranged linearly in the direction indicated by the arrow X in FIG. 7 on the photolithography machine 100, and driven by the corresponding laser light source driving sections 11A, 11B, - - - (which are also collectively referred to as “laser light source driving sections 11”). Each of the laser beam emitting sections 10 may be, for example, comprised of a semiconductor laser.

The light receiving section 120 comprises a silicon-based light receiving element, which is moved by a moving section 61 in the direction indicated by the arrow X described above, and sequentially placed at the positions for receiving the respective laser beams. When the light receiving section 120 is moved by the moving section 61, the optical filter 140 placed on the light receiving surface of the light receiving section 120 is also moved with the optical filter 140 being placed on the light receiving surface of the light receiving section 120.

The photosensitive material 1 may be a substrate with photoresist being applied thereon for producing a two-dimensional circuit pattern for use with a printed circuit board, crystal display board, or plasma display board.

The photolithography machine 100 has a mounting board 62 on which the photosensitive material 1 and moving section 61 are mounted, a conveyor section 63 for conveying the mounting board in the direction indicated by the arrow Y in FIG. 7, which is orthogonal to the X direction described above, and a controller for controlling the overall operation of the machine, including operation of each of the components described above, input/output signal timings, and the like, in addition to the laser beam emitting sections 10 and laser light source driving sections 11. The moving section 61 and photosensitive material 1 are disposed in the Y direction on the mounting board 62.

The output value outputted from the light receiving section 120 may be the output value for indicating the optical power of the laser beam per unit time received by the light receiving section 120, or if the laser beam outputted from the laser beam emitting sections 10 is a pulse laser, it may be the output for indicating the optical power of a single pulse received by the light receiving section 120 or the like.

Hereinafter, the adjustment of the optical power of each of the laser beams emitted from the laser beam emitting sections 10 by the optical power adjusting apparatus 101 will be described.

The moving section 61 moves the light receiving section 120 in the X direction described above, and places it at the receiving position Ga for receiving the laser beam emitted from the laser beam emitting section 10A. The light receiving section 120 placed at the receiving position Ga receives the laser beam having a wavelength λa emitted from the laser beam emitting section 10A for exposing the photosensitive material 1, and the output value outputted from the light receiving section 120 for the laser beam received thereby is inputted to the optical power adjusting section 130.

The optical power adjusting section 130 controls the laser light source driving section 11A so that the driving current to be supplied from the laser light source driving section 11A to the laser beam emitting section 10A is adjusted such that the output value outputted from the light receiving section 120 for the laser beam emitted from the laser beam emitting section 10A for exposing the photoconductive material 1 corresponds to the value Qo described above (FIG. 8). After the optical power of the laser beam emitted from the laser beam emitting section 10A is adjusted such that the output value outputted from the light receiving section 120 corresponds to the value Qo described above, the optical power adjusting section 130 outputs a signal for clamping the optical power of the laser beam at the adjusted optical power emitted from the laser beam emitting section 10A to the laser light source driving section 11A, which in turn clamps the optical power at the adjusted value. This concludes the adjustment of the optical power of the laser beam emitted from the laser beam emitting section 10A.

Next, the moving section 61 moves the light receiving section 120 in the X direction, and places it at the receiving position Gb for receiving the laser beam emitted from the laser beam emitting section 10B. The light receiving section 120 placed at the receiving position Gb receives the laser beam having a wavelength λb emitted from the laser beam emitting section 10B, and the output value outputted from the light receiving section 120 for the laser beam received thereby is inputted to the optical power adjusting section 130.

The optical power adjusting section 130 controls the laser light source driving section 11B so that the driving current to be supplied from the laser light source driving section 11B to the laser beam emitting section 10B is adjusted such that the output value outputted from the light receiving section 120 for the laser beam emitted from the laser beam emitting section 10B corresponds to the value Qo in the same manner as described above. After the optical power of the laser beam emitted from the laser beam emitting section 10B is adjusted such that the output value outputted from the light receiving section 120 corresponds to the value Qo described above, the optical power adjusting section 130 outputs a signal for clamping the optical power of the laser beam at the adjusted value emitted from the laser beam emitting section 10B to the laser light source driving section 11B, which in turn clamps the optical power at the adjusted value in the same manner as described above. This concludes the adjustment of the optical power of the laser beam emitted from the laser beam emitting section 10B.

Thereafter, the light receiving section 120 is placed in sequence at the receiving positions Gc, Gd, - - - for receiving the laser beams emitted from the laser beam emitting sections 10C, 10D, - - - respectively, and the optical power of the light beam emitted from the laser beam emitting sections 10C, 10D, - - - is adjusted by the optical power adjusting section 130 each time the light receiving section 120 is placed at the receiving positions Gc, Gd, - - - such that the output value outputted from the light receiving section 120 corresponds to the value Qo described above, and the optical power of the laser beam emitted from the laser beam emitting sections 10C, 10D, - - - is clamped by each of the laser light source driving section 11C, 11D, - - - . In this way, the adjustment of the optical power of all laser beam emitting sections 10A, 10B, - - - is completed.

When the adjustment of the optical power of each of the laser beams emitted from the laser beam emitting sections 10 is completed, the conveyor section 63 conveys the mounting board 62 in the direction indicated by the arrow Y which is orthogonal to the direction indicated by the arrow X in which the laser beam emitting sections 10A, 10B, - - - are arranged.

The controller 50 controls the laser beam emitting sections 10 or laser light source driving sections 11 so that the laser beams emitted from the laser beam emitting sections 10A, 10B, - - - are switched on and off in synchronization with the conveyance of the mounting board 62 such that the image indicated by the image data which have been inputted and stored in an image drawing section 65 is recorded on the photosensitive material 1 placed on the mounting board 62. This causes the image described above to be exposed on the photosensitive material 1. Here, the optical power of each of the laser beams emitted from the laser beam emitting sections 10A, 10B, - - - is a clamped value as described above, so that the exposure level for the image exposed on the photosensitive material corresponds to the predetermined constant level.

The optical power of each of the laser beams emitted from the laser beam emitting sections may be adjusted by disposing an aperture structure on the laser beam emitting section for limiting the cross sectional area of the light path of the laser beam and adjusting the aperture, as well as by adjusting the driving current to be supplied to the laser light source.

By adjusting the optical power of each of the laser beams emitted from the laser beam emitting sections in the manner described above, the photosensitive material 1 may be exposed at the predetermined constant exposure level even if each of the laser beams emitted from the laser beam emitting sections has a different wavelength, so that unevenness of exposure of the photosensitive material may be prevented. Further, when wavelength of the laser beam emitted from the laser beam emitting section is shifted due to changes in temperature or characteristic over time, the optical power of each of the laser beams emitted from the laser beam emitting sections may be adjusted simply in the same manner as described above without measuring the wavelength of each of the laser beams emitted from the laser emitting sections, thereby the time and cost required for measuring the wavelength may be eliminated.

The optical filter described above may be placed at a position remote from the light receiving surface between the laser beam emitting section and light receiving section, as well as on the light receiving surface of the light receiving section.

The light receiving section is not limited to those composed of a silicon-based light receiving element, and it may be composed of anything as long as it is capable of outputting an output value that indicates the optical power of the light beam received.

Further, the light emitting means is not limited to those that emit a laser beam having a narrow wavelength range obtained from a single laser light source, but it may be those that emit a combined laser beam having a wider wavelength range obtained by combining laser beams emitted from a plurality of laser light sources. In addition, the light emitting means is not limited to those that emit a laser beam, but it may be those that emit a light beam having a wide wavelength range obtained from a halogen or mercury lamp, or the like. That is, the light beams having a wide wavelength range may be received by the light receiving section, and the output value outputted from the light receiving section may be adjusted to the predetermined constant value, thereby the photosensitive material may be exposed at the predetermined constant exposure level. In this way, the optical power adjusting method and apparatus according to the present invention may be applied to the light beam having a wide wavelength range, so that the optical power adjusting method described above may be applied, for example, to the photolithography machine as described, for example, in Japanese Unexamined Patent Application No. 2002-202442 proposed by the applicant. That is, the optical power of each combined laser beam emitted from the exposure heads acting as the light emitting means of the photolithography machine described above may be adjusted using the optical power adjusting method described above.

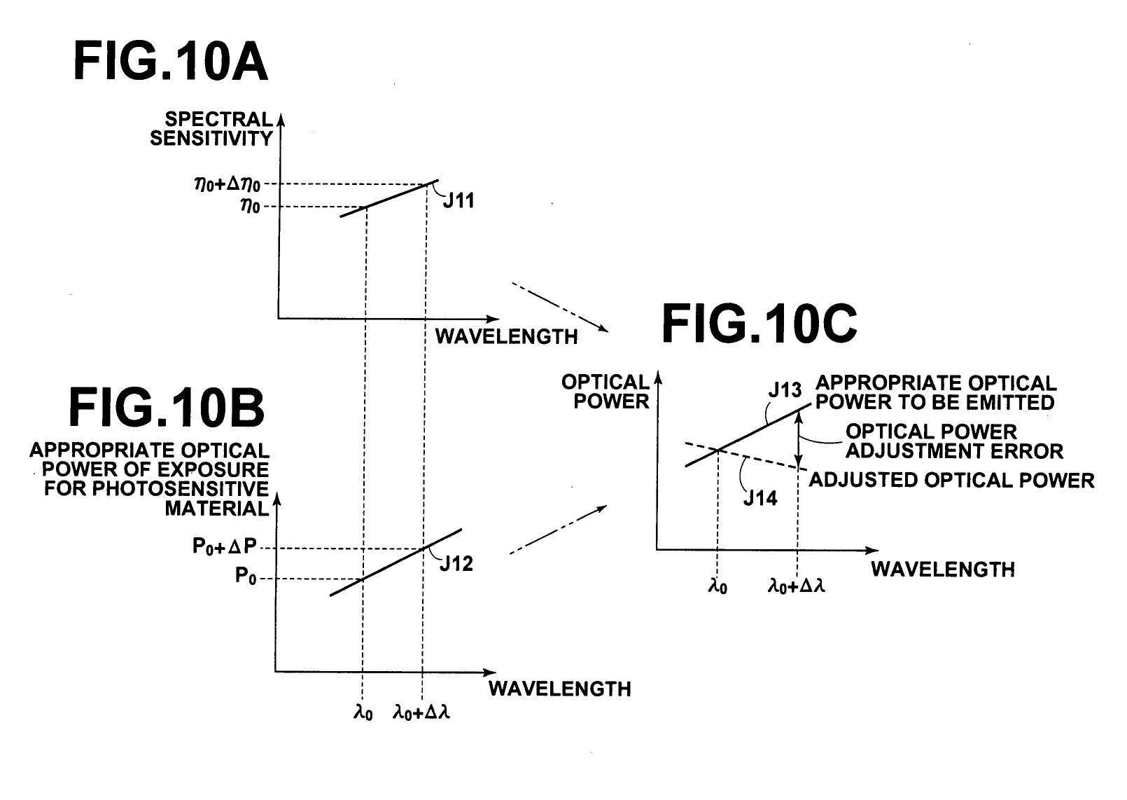

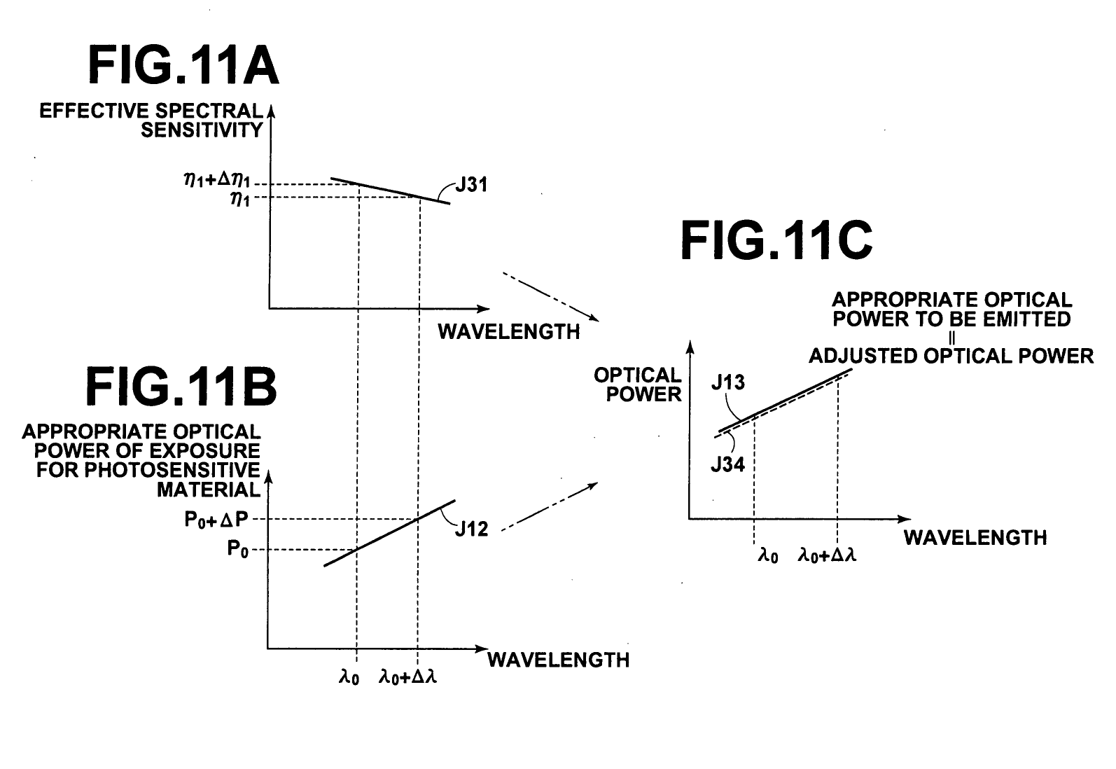

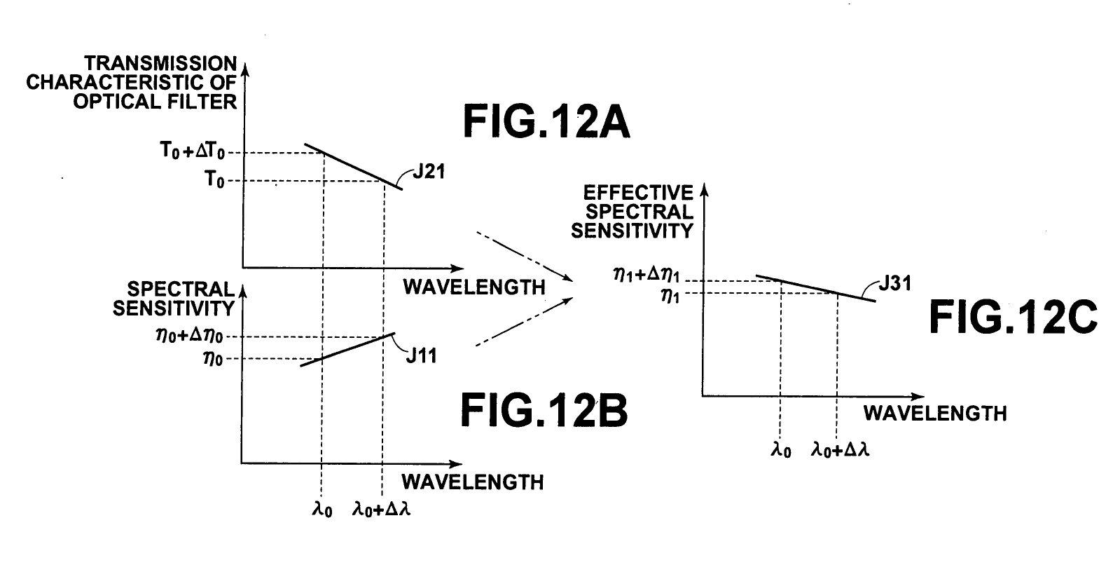

Hereinafter, detailed description of how unevenness in image quality that may be developed in an image exposed on the photosensitive material is avoided by appropriately setting the transmission characteristic of the optical filter will be provided. The unevenness in image quality arises, for example, from the wavelength dependency of the sensitivity of the light receiving section and photosensitive material when an image is exposed on the photosensitive material using light beams having different wavelengths with each other emitted from a plurality of light emitting sections. FIG. 9 is a graph illustrating the spectral sensitivity characteristic of the light receiving section. FIGS. 10A, 10B and 10C illustrate an optical power adjustment error arising from the spectral sensitivity characteristic of the light receiving section and the wavelength dependency of the photosensitive material for the appropriate optical power of exposure. FIGS. 11A, 11B and 11C illustrate the relationship between the adjusted optical power when the optical filter is placed on the light receiving section and appropriate optical power to be emitted. FIGS. 12A, 12B and 12C illustrate the effective spectral sensitivity characteristic when the optical filter is placed on the light receiving section. The terms “appropriate optical power of exposure”, “optical power adjustment error”, “appropriate optical power to be emitted”, “adjusted optical power”, and “effective spectral sensitivity characteristic” will be elaborated in the following description.

Here, it is assumed that the peak wavelengths of the light beams emitted from a plurality of light emitting sections are distributed within the range from λo to λo+Δλ, and each peak wavelength may fluctuate within the range of Δλ. The line Jo in FIG. 9 illustrates a general spectral sensitivity characteristic of a light receiving section comprised of a silicon-based light receiving element. FIG. 10A illustrates a portion of Jo in FIG. 9 within the wavelength range described above in enlarged form, which is represented by the line J11.

The relationship among the optical power P received by the light receiving section per unit time, optoelectrically converted current value I, which is the output value optoelectrically converted and outputted from the light receiving section, indicating the optical power P, and the sensitivity of the light receiving section η may be expressed by Formula 5 below.
I=η·P Formula 5

Here, the sensitivity of the light receiving section is wavelength dependent so that the optical power of the light beam emitted from the light emitting section per unit time required for obtaining a certain constant output value from the light receiving section (hereinafter referred to as “adjusted optical power”) varies with the wavelength. For example, if the sensitivity of the light receiving section having wavelength dependency as illustrated by the line J11 in FIG. 10A is higher by 10% on the longer wavelength side (λo+Δλ) than that of the shorter wavelength side (λo), the adjusted optical power described above on the longer wavelength side becomes smaller by approximately 10% than that of the shorter wavelength side as illustrated by the line J14 in FIG. 10C. Also, the “appropriate optical power of exposure” which is the optical power required for exposing the photosensitive material at a predetermined constant level varies with the wavelength of the light beam used for exposing the photosensitive material. For example, when the appropriate optical power of exposure on the longer wavelength side is greater than that of the shorter wavelength side as illustrated by the line J12 in FIG. 10B, the “appropriate optical power to be emitted” which is the optical power to be emitted from the light emitting section per unit time for exposing the photosensitive material on the photolithography machine at the predetermined constant level becomes greater on the longer wavelength side than on the shorter wavelength side as illustrated by the line J13 in FIG. 10C. Here, when the optical power emitted from the light emitting section is the appropriate optical power to be emitted, the photosensitive material is exposed by the appropriate optical power of exposure described above.

Therefore, even when the optical power emitted from the light emitting section per unit time is adjusted such that a predetermined constant output value is outputted from the light receiving section, the adjustment error of the optical power (hereinafter referred to as “optical power adjustment error) occurs as indicated by the difference between the lines J14 and J13, so that the adjusted optical power (J14 in FIG. 10C) does not correspond to the appropriate optical power to be emitted (J13 in FIG. 10C). That is, the light beam with a wavelength in the wavelength range described above does not satisfy the relationship with respect to the optical power and wavelength required for exposing the photosensitive material at the predetermined constant level.

Thus, the amount of optical power adjustment error differs with the wavelength. For example, the light beam having a shorter wavelength close to the wavelength λo among the light beams emitted from a plurality of light emitting sections may expose the photosensitive material at the appropriate optical power of exposure, but the light beam having a longer wavelength close to the wavelength λo+Δλ exposes the photosensitive material with a far smaller optical power of exposure than the appropriate optical power of exposure, thereby unevenness in image quality may be developed for the image obtained by exposing the photosensitive material using light beams having different wavelengths with each other emitted from a plurality of light emitting sections.

In contrast, if the optical power of each of the light beams emitted from the light emitting sections per unit time is adjusted such that the optical power adjustment error is minimized, i.e., the adjusted optical power corresponds to the appropriate optical power of exposure and at the same time, the predetermined constant output value is outputted from the light receiving section, then the optical power of each of the light beams emitted from the light emitting sections may be adjusted to the appropriate optical power of exposure, thereby the photosensitive material may be exposed at the predetermined constant exposure level.

Consequently, an optical filter is placed on the front surface of the light receiving section to cancel out the changes in each of the characteristics caused by the variations in the wavelength described above so that the adjusted optical power may corresponds to the appropriate optical power to be emitted. That is, the effective spectral sensitivity of the light receiving section which is the combined characteristics of the transmission characteristic of the optical filter and spectral sensitivity of the light receiving section (hereinafter referred to as “effective spectral sensitivity”) is set such that the adjusted optical power corresponds to the appropriate optical power to be emitted. In this way, the effects arising from the wavelength dependency of the sensitivity of the light receiving section (FIG. 10A) and of the appropriate optical power of exposure (FIG. 10B) for the photosensitive material may be cancelled out by the effective spectral sensitivity characteristic described above, so that the optical power of each of the light beams emitted from the light emitting sections per unit time may be adjusted to the appropriate optical power to be emitted by adjusting the optical power of each of the light beams emitted from the light emitting sections such that the predetermined constant output value is outputted from the light receiving section.

More specifically, the appropriate optical power to be emitted is determined as illustrated by the line J13 based on the appropriate optical power of exposure for the photosensitive material illustrated by the line J12 in FIG. 11B, and the effective spectral sensitivity of the light receiving section is set (line J31 in FIG. 11A) such that the adjusted optical power (line J34 in FIG. 11C) corresponds to the appropriate optical power to be emitted (line J13 in FIG. 11C). Setting of the effective spectral sensitivity may be implemented by setting the transmission characteristic of the optical filter in the following manner. The effective spectral sensitivity may be determined by combining the transmission characteristic of the optical filter and the spectral sensitivity characteristic of the light receiving section illustrated by the line J11 in FIG. 12B, so that the transmission characteristic of the optical filter (line J21 in FIG. 12A) may be set based on the effective spectral sensitivity indicated by the line J31 in FIG. 12C and spectral sensitivity indicated by the line J11 such that the combined effective spectral sensitivity characteristic corresponds to that indicated by the line J31 in FIG. 12C (or that indicated by the line J31 in FIG. 11A).

Thereafter, the optical power of each of the light beams emitted from the light emitting sections per unit time is adjusted such that the predetermined constant output value is outputted from the light receiving section, thereby the optical power of each of the light beams may be adjusted to the appropriate optical power to be emitted. In this way, the optical power of each of the light beams emitted from the light emitting sections may be adjusted to the appropriate optical power to be emitted simply by adjusting the output value outputted from the light receiving section to the predetermined constant value without regard to the difference in wavelength of each of the light beams emitted from the light emitting sections, and unevenness in image quality that may occur in the image exposed on the photosensitive material may be prevented.

1. An optical power adjusting method for adjusting the optical power of a light beam or beams to be emitted from a light emitting section or sections for exposing a photosensitive material comprising the steps of:
(a) determining an intended exposure level of a photosensitive material to be exposed with the use of said light beam or beams, and
(b) adjusting said optical power based on the difference between the exposure level of said photosensitive material obtained by said light beam or beams, which is dependent on the optical power and wavelength thereof, and said intended exposure level.

2. The optical power adjusting method according to claim 1, wherein said optical power adjustment is implemented based on the difference between the output value obtained by receiving said light beam having a known wavelength by a light receiving element and the corresponding value to said intended exposure level at said wavelength.

3. The optical power adjusting method according to claim 1, wherein said optical power adjustment is implemented based on the difference between the output value obtained by receiving said light beam by a light receiving element through an optical filter and the value corresponding to said intended exposure level, wherein the transmission characteristic of said optical filter is adjusted such that said output value indicates the characteristic that corresponds to the exposure level of said photosensitive material based on the wavelength characteristic of said light receiving element and said photosensitive material.

4. The optical power adjusting method according to claim 1, wherein said method is adapted to implement said optical power adjustment for each of said light beams emitted from a plurality of said light emitting sections and said step (b) comprises the steps of:
obtaining the relationship between the output value outputted from said light receiving section when a light beam that satisfies the relationship with respect to the optical power and wavelength required for exposing said photosensitive material at said intended exposure level is received thereby and the wavelength of said light beam in advance,
receiving each of said light beams emitted from said plurality of light emitting sections separately by said light receiving section, and
adjusting said optical power of each of said light beams emitted from said plurality of light emitting sections such that each of the output values outputted from said light receiving section for each of said light beams received separately by said light receiving section satisfies said relationship between said output value and wavelength.

5. The optical power adjusting method according to claim 1, wherein_said method is adapted to implement said optical power adjustment for each of said light beams emitted from a plurality of said light emitting sections and said step (b) comprises the_steps of:
providing an optical filter having an optical transmission characteristic that causes said light receiving section to output a predetermined constant output value when a light beam that satisfies the relationship between the optical power and wavelength required for exposing said photosensitive material at said intended exposure level is received thereby through said optical filter,
receiving each of said light beams emitted from said plurality of light emitting sections separately by said light receiving section through said optical filter, and
adjusting said optical power of each of said light beams emitted from said plurality of light emitting sections such that each of the output values outputted from said light receiving section for each of said light beams received separately by said light receiving section corresponds to said predetermined constant output value.

6. An optical power adjusting apparatus comprising:
a light receiving section for receiving a light beam or beams emitted from a light emitting section or sections for exposing a photosensitive material to obtain the optical power of said light beam or beams, and
correcting section for correcting said optical power based on the difference between the exposure level of said photosensitive material obtained by said light beam or beams, which is dependent on the optical power and wavelength thereof, and an intended exposure level of said photosensitive material.

7. The optical power adjusting apparatus according to claim 6, wherein said light receiving section is configured to receive each of said light beams emitted from a plurality of said light emitting sections separately and to output the output value that indicates the optical power of each of said light beams, and said correcting section comprises an optical power adjusting section for adjusting the optical power of each of said light beams emitted from said plurality of light emitting sections and a storage section for storing the output value/wavelength relationship, which is the relationship between the output value outputted from said light receiving section when a light beam that satisfies the relationship with respect to the optical power and wavelength required for exposing said photosensitive material at a predetermined constant exposure level is received thereby, and said wavelength, wherein each of said light beams emitted from said plurality of light emitting sections is received separately by said light receiving section, and said optical power of each of said light beams to be emitted from said plurality of light emitting sections is adjusted by said optical power adjusting section such that each of the output values outputted from said light receiving section for each of said light beams received separately by said light receiving section satisfies said output value/wavelength relationship stored in said storage section.

8. The optical power adjusting apparatus according to claim 6, wherein said light receiving section is configured to receive each of said light beams emitted from a plurality of said light emitting sections separately, and said correcting section comprises an optical filter disposed between said light emitting section and light receiving section, having an optical transmission characteristic that causes said light receiving section to output a predetermined constant output value when a light beam that satisfies the relationship with respect to the optical power and wavelength required for exposing said photosensitive material at a predetermined constant exposure level is received thereby through said optical filter, and an optical power adjusting section for adjusting said optical power of each of said light beams emitted from said plurality of light emitting sections such that each of the output values outputted from said light receiving section for each of said light beams received separately by said light receiving section through said optical filter corresponds to said predetermined constant output value.
